(19) United States
(12) Patent Application Publication
(10) Pub. No.: US 2026/0160563 A1
(43) Pub. Date: Jun. 11, 2026

(54) METHOD AND SYSTEM FOR OPTIMIZING ROUTE FOR A USER

(71) Applicant: Yatnavat Technologies Private Limited, Mumbai (IN)

(72) Inventors: Umeshpratap Singh, Navi Mumbai (IN); Sagar Samarendra Mishra, Thane (IN)

(73) Assignee: Yatnavat Technologies Private Limited, Mumbai (IN)

(21) Appl. No.: 19/409,853

(22) Filed: Dec. 5, 2025

(30) Foreign Application Priority Data
Dec. 6, 2024 (IN) 202421096535

(51) Int. Cl. G01C 21/34

(52) U.S. Cl. CPC G01C 21/3446; G01C 21/3415; G01C 21/3492

(57) ABSTRACT

The present disclosure talks about a method and system for optimizing route for a user. The method includes integrating a road geographical information system with a graph database system, dynamically updating an integrated system of the road geographical information system with the graph database system, denoting one or more edge properties to a plurality of edges, dynamically updating the one or more edge properties based on a historical real-trip data, creating one or more clusters of a set of nodes of the plurality of nodes, determining the optimized route for the user for travelling from a first location to a second location, rendering the optimized route on a communication device of the user and generating one or more signals pertaining to one or more alert signals corresponding to the optimization of the route for the travel from the first location to the second location.

### CROSS-REFERENCE TO RELATED APPLICATIONS

The present application claims the benefit of Indian Patent Application No. 202421096535, filed Dec. 6, 2024, all of which are hereby incorporated by reference in their entirety for all purposes.

### TECHNICAL FIELD

The present invention relates to the field of navigation subsystems and routing technologies, and in particular, relates to a method and system for real time, dynamic and adaptive based optimization of route for a user.

### INTRODUCTION

Recent advancements in routing applications represent a significant evolution in the field of navigation and traffic management. These applications incorporate sophisticated technologies to enhance routing precision and user experience. In addition, these applications utilize real-time data integration, machine learning algorithms, and artificial intelligence to deliver adaptive routing solutions that dynamically adjust to changing conditions. Moreover, these applications provide optimized route recommendations with unprecedented accuracy by incorporating variables such as traffic flow, road closures, and meteorological factors. The advancements enable substantial improvements in travel efficiency, fuel economy, and congestion mitigation. Furthermore, these routing technologies contribute to environmental sustainability by minimizing vehicular emissions and support enhanced logistical operations. This ultimately advances productivity and operational effectiveness in both personal and commercial transportation domains.

The routing applications are known as GIS-based mapping applications. These applications leverage sophisticated Geographic Information Systems (GIS) to provide users with highly accurate, real-time data crucial for a wide array of purposes. These applications have become essential for logistics companies and enterprises with complex routing and navigation needs. The GIS-based mapping applications deliver detailed information on routes, distances, and travel times. They offer a comprehensive view of travel conditions that is continuously updated. This real-time data is pivotal for businesses that depend on precise navigation to optimize their operations. For instance, a logistics company can use these applications to determine the most efficient routes for delivery vehicles, taking into account factors like current traffic conditions, road closures, and potential delays. This capability significantly enhances operational efficiency by minimizing travel time and fuel consumption, thereby reducing overall operational costs. Additionally, the GIS-based mapping applications support a range of functionalities beyond basic navigation. They enable businesses to perform advanced route planning, analyze traffic patterns, and even forecast potential disruptions. This level of detail and flexibility allows companies to tailor their strategies to specific needs and conditions, further enhancing their ability to deliver goods and services efficiently.

However, traditional route optimization methods, which typically depend on APIs utilizing latitude and longitude coordinates, encounter several significant challenges. Latitude and longitude data are fundamental for calculating routes and distances. However, managing and analyzing this spatial data presents complex issues. The vast quantity of data sets required to cover numerous locations results in substantial storage demands. The complexity of handling this increases as the number of coordinates grows, which often leads to high computational overhead. This computational burden can impact the performance of route optimization algorithms, making real-time adjustments and updates more challenging.

Additionally, the precision of latitude-longitude pairs, being continuous and highly granular, complicates the comparison, search, and storage of nearby points. Even a minute change or a slight change in coordinates can result in substantially different lat-long values. The accuracy of these coordinates can vary based on external factors, such as GPS satellite network availability, making consistent capture of precise geographic data difficult. Also, the best route between two locations can vary depending on whether the criteria are shortest, fastest, or most cost-efficient. There may be multiple possible routes and the most optimized route is not always the shortest in distance. Moreover, many routing applications face limitations in the number of points that can be included in route calculations. Example, distance matrix constraints often cap the number at 25, which impedes the optimization for larger sets of points. Lastly, a significant challenge is the lack of customization options. Most applications do not allow users to incorporate their routing history or additional data to tailor the service to specific needs. This restricts the ability to enhance the routing service based on individual requirements and historical data. These challenges underscore the need for ongoing innovation and refinement in routing applications.

### SUMMARY

In a first example, a computer-implemented method is provided. The computer-implemented method enables optimization of route for a user. The computer-implemented method includes a first step of integrating a road geographical information system with a graph database system. The computer-implemented method includes a second step of dynamically updating an integrated system of the road geographical information system with the graph database system based on an updated first set of data. The computer-implemented method includes a third step of denoting, by the one or more processors, one or more edge properties to the plurality of edges on at least one level of a plurality of levels. The computer-implemented method includes a fourth step of dynamically updating the one or more edge properties based on a historical real-trip data fetched from one of a historical trip database or a third party data source. The computer-implemented method includes a fifth step of creating one or more clusters of a set of nodes of the plurality of nodes based on a travel corresponding to at least one trip based on the historical real-trip data. The computer-implemented method includes a sixth step of determining the optimized route for the user for travelling from a first location to a second location. The computer-implemented method includes a seventh step of rendering the optimized route on a communication device of the user. The integration of the road geographical information system with the graph database system includes collecting a spatial aware data from one or more third party sources, extracting a first set of data from the spatial aware data from the one or more third party sources, converting the first set of data into plurality of nodes and a plurality of edges and applying graph database theory on the first set of data based on the converted plurality of nodes and the plurality of edges for enabling the integration of the road geographical information system with the graph database system. Each node of the plurality of nodes represents a set of prominent points. The plurality of edges connects the plurality of nodes. The plurality of nodes and the plurality of edges are captured using a grid of a pre-defined size at a corresponding geohash precision level. The integration corresponds to merging the graph database system with the road geographical information system. The one or more edge properties are denoted using a set of parameters. The set of parameters are determined based on the first set of data. The one or more clusters are created using geohashing technique starting from a first geohash precision level to at least a second geohash precision level. The one or more clusters correspond to one or more sub-graphs in the graph database system. The determining of the optimized route includes receiving a second set of data from a communication device associated with a user, identifying a first node and a second node on the graph database system and determining the optimized route for the travel from the first node nearest from the first location to the second node nearest from the second location. The second set of data includes the first location, the second location and at least one of a plurality of travel-related contexts. The first node is a closest node on the graph database system to the first location and the second node is a closest node of the graph database system to the second location. The optimized route is determined at a corresponding geohash precision level. The geohash precision level for determining the optimized route is taken based on at least one of a set of pre-defined criteria. The optimized route is determined by fetching one or more routes from the first location to the second location based on the historical real-trip data, identifying at least a first point along on the one or more routes between with the first location and the second location, and determining the optimized route based on the identified first point, the first node, the second node and the at least one of the plurality of travel related contexts. The first point is determined based on the set of pre-defined criteria. The first point is a point connecting a set of nodes and a set of edges corresponding to the one or more routes to a node associated with the first point on the graph database system. The instruction signal generator generates one or more signals pertaining to one or more alert signals corresponding to the optimization of the route for the travel from the first location to the second location. The computer-implemented method enables reduction in storage space requirements by enabling storing and fetching relevant node data in the graph database system based on the plurality of travel related contexts. In addition, the computer-implemented method enables storing data associated with grids containing road data. The computer-implemented method enables improvement in computational performance and increases calculation speed for the optimized route based on a context provided by the user.

In an embodiment of the present disclosure, the integration of the graph database system with geographical information system enables usage of properties of the graph database system over and above the geographical information system.

In an embodiment of the present disclosure, the one or more edge properties correspond to time-based property, distance-based property, road type-based property, one or more restrictions, road orientation, road position and speed-based property.

In an embodiment of the present disclosure, the plurality of levels includes time-based edge property, distance-based edge property and number of nodes in between a start node and an end node for each corresponding travel route.

In an embodiment of the present disclosure, the plurality of travel related contexts includes a time-based context, a distance-based context, a road type-based context, a speed limit-based context, nodes-based context and limitations on usage of certain types of roads and avoiding one or more areas.

In an embodiment of the present disclosure, the optimized route includes a first set of nodes of the plurality of nodes connected using a first set of edges of the plurality of edges. The first set of edges are connected based on edge properties determined based on at least one travel related context of the plurality of travel related contexts.

In an embodiment of the present disclosure, each of the plurality of nodes has a pre-defined shape and a pre-defined area for each geohash level. The area for each of the plurality of nodes is uniform.

In an embodiment of the present disclosure, the creation of the one or more clusters of the set of nodes of the plurality of nodes includes identifying at least a first node based on a first location of a user for travel to a second location. The first node is a nearest point on a road from the first location. In addition, the creation of the one or more clusters includes determining the set of nodes prominent to the identified first node corresponding to the travel to the second location. The set of nodes are determined based on the historical real-trip data corresponding to the travel from the first location to the second location. Further, the creation of the one or more clusters includes dynamically updating the one or more clusters based on updated trip data.

In an embodiment of the present disclosure, the creation of the one or more clusters of the set of nodes includes identifying the set of nodes prominent to the identified first node using the grid at each corresponding geohash precision level. A size of the grid at each corresponding geohash precision level increases with increase in the geohash precision level.

In an embodiment of the present disclosure, the grid of the pre-defined size at each subsequent geohash precision level other than the first geohash precision level is a combination of a plurality of grids at a previous geohash precision level.

In an embodiment of the present disclosure, the set of pre-defined criteria includes one or a combination of at least one cluster of a set of nodes existing between the first location and the second location, a type of travel and at least one travel related context selected from the plurality of travel-related contexts. The type of travel includes one of a hyperlocal travel, an inter-state travel and an intra-state travel.

In a second example, a computer system is provided. The computer system performs optimization of route for a user. The computer system includes a main server and an instruction signal generator. The main server a memory and one or more processors. The one or more processors are operatively coupled to the memory. The one or more processors is configured to perform a set of instructions. The set of instructions includes a first step of integrating a road geographical information system with a graph database system. The set of instructions includes a second step of dynamically updating an integrated system of the road geographical information system with the graph database system based on an updated first set of data. The set of instructions includes a third step of denoting, by the one or more processors, one or more edge properties to the plurality of edges on at least one level of a plurality of levels. The set of instructions includes a fourth step of dynamically updating the one or more edge properties based on a historical real-trip data fetched from one of a historical trip database or a third party data source. The set of instructions includes a fifth step of creating one or more clusters of a set of nodes of the plurality of nodes based on a travel corresponding to at least one trip based on the historical real-trip data. The set of instructions includes a sixth step of determining the optimized route for the user for travelling from a first location to a second location. The set of instructions includes a seventh step of rendering the optimized route on a communication device of the user. The integration of the road geographical information system with the graph database system includes collecting a spatial aware data from one or more third party sources, extracting a first set of data from the spatial aware data from the one or more third party sources, converting the first set of data into plurality of nodes and a plurality of edges and applying graph database theory on the first set of data based on the converted plurality of nodes and the plurality of edges for enabling the integration of the road geographical information system with the graph database system. Each node of the plurality of nodes represents a set of prominent points. The plurality of edges connects the plurality of nodes. The plurality of nodes and the plurality of edges are captured using a grid of a pre-defined size at a corresponding geohash precision level. The integration corresponds to merging the graph database system with the road geographical information system. The one or more edge properties are denoted using a set of parameters. The set of parameters are determined based on the first set of data. The one or more clusters are created using geohashing technique starting from a first geohash precision level to at least a second geohash precision level. The one or more clusters correspond to one or more sub-graphs in the graph database system. The determining the optimized route includes receiving a second set of data from a communication device associated with a user, identifying a first node and a second node on the graph database system and determining the optimized route for the travel from the first node nearest from the first location to the second node nearest from the second location. The second set of data includes the first location, the second location and at least one of a plurality of travel related contexts. The first node is a closest node on the graph database system to the first location and the second node is a closest node of the graph database system to the second location. The optimized route is determined at a corresponding geohash precision level. The geohash precision level for determining the optimized route is taken based on at least one of a set of pre-defined criteria. The optimized route is determined by fetching one or more routes from the first location to the second location based on the historical real-trip data, identifying at least a first point along on the one or more routes between with the first location and the second location, and determining the optimized route based on the identified first point, the first node, the second node and the at least one of the plurality of travel related contexts. The first point is determined based on the set of pre-defined criteria. The first point is a point connecting a set of nodes and a set of edges corresponding to the one or more routes to a node associated with the first point on the graph database system. The instruction signal generator generates one or more signals pertaining to one or more alert signals corresponding to the optimization of the route for the travel from the first location to the second location. The computer system enables reduction in storage space requirements by enabling storing and fetching relevant node data in the graph database system based on the plurality of travel related contexts. In addition, the computer system enables storing data associated with grids containing road data. The computer system enables improvement in computational performance and increases calculation speed for the optimized route based on a context provided by the user.

In a third example, a non-transitory computer readable medium is provided. The non-transitory computer readable medium encodes computer executable instructions that, when executed by at least one processor, performs a method to enable real time, dynamic and adaptive based optimization of route for a user. The method includes a first step of integrating a road geographical information system with a graph database system. The method includes a second step of dynamically updating an integrated system of the road geographical information system with the graph database system based on an updated first set of data. The method includes a third step of denoting one or more edge properties to the plurality of edges on at least one level of a plurality of levels. The method includes a fourth step of dynamically updating the one or more edge properties based on a historical real-trip data fetched from one of a historical trip database or a third party data source. The method includes a fifth step of creating one or more clusters of a set of nodes of the plurality of nodes based on a travel corresponding to at least one trip based on the historical real-trip data. The method includes a sixth step of determining the optimized route for the user for travelling from a first location to a second location. The method includes a seventh step of rendering the optimized route on a communication device of the user. The method includes an eighth step of generating one or more signals pertaining to one or more alert signals corresponding to the optimization of the route for the travel from the first location to the second location. The integration of the road geographical information system with the graph database system includes collecting a spatial aware data from one or more third party sources, extracting a first set of data from the spatial aware data from the one or more third party sources, converting the first set of data into plurality of nodes and a plurality of edges and applying graph database theory on the first set of data based on the converted plurality of nodes and the plurality of edges for enabling the integration of the road geographical information system with the graph database system. Each node of the plurality of nodes represents a set of prominent points. The plurality of edges connects the plurality of nodes. The plurality of nodes and the plurality of edges are captured using a grid of a pre-defined size at a corresponding geohash precision level. The integration corresponds to merging the graph database system with the road geographical information system. The one or more edge properties are denoted using a set of parameters. The set of parameters are determined based on the first set of data. The one or more clusters are created using geohashing technique starting from a first geohash precision level to at least a second geohash precision level. The one or more clusters correspond to one or more sub-graphs in the graph database system. The determining the optimized route includes receiving a second set of data from a communication device associated with a user, identifying a first node and a second node on the graph database system and determining the optimized route for the travel from the first node nearest from the first location to the second node nearest from the second location. The second set of data includes the first location, the second location and at least one of a plurality of travel related contexts. The first node is a closest node on the graph database system to the first location and the second node is a closest node of the graph database system to the second location. The optimized route is determined at a corresponding geohash precision level. The geohash precision level for determining the optimized route is taken based on at least one of a set of pre-defined criteria. The optimized route is determined by fetching one or more routes from the first location to the second location based on the historical real-trip data, identifying at least a first point along on the one or more routes between with the first location and the second location, and determining the optimized route based on the identified first point, the first node, the second node and the at least one of the plurality of travel related contexts. The first point is determined based on the set of pre-defined criteria. The first point is a point connecting a set of nodes and a set of edges corresponding to the one or more routes to a node associated with the first point on the graph database system. The method enables reduction in storage space requirements by enabling storing and fetching relevant node data in the graph database system based on the plurality of travel related contexts. In addition, the method enables storing data associated with grids containing road data. The method enables improvement in computational performance and increases calculation speed for the optimized route based on a context provided by the user.

### BRIEF DESCRIPTION OF THE DRAWINGS

Having thus described the invention in general terms, references will now be made to the accompanying figures, wherein:

FIG. 1 illustrates a system for optimizing a route for a user, in accordance with various embodiments of the present disclosure;

FIG. 2 illustrates a block diagram of an integration module for integrating road geographic information system with graph database theory, in accordance with an embodiment of the present disclosure;

FIG. 3 illustrates a graphical representation of an exemplary geographical region illustrating polylines, in accordance with various embodiments of the present disclosure;

FIG. 4 illustrates a graphical representation of the exemplary geographical region of FIG. 3 illustrating nodes and polylines, in accordance with various embodiments of the present disclosure;

FIG. 5 illustrates a graphical representation of the exemplary geographical region of edges connecting two geographical locations of a specific region, in accordance with various embodiments of the present disclosure;

FIG. 6 illustrates a flowchart of a method for optimizing a route for a user, in accordance with various embodiments of the present disclosure; and

FIG. 7 illustrates a block diagram of a computing device, in accordance with various embodiments of the present invention.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced items.

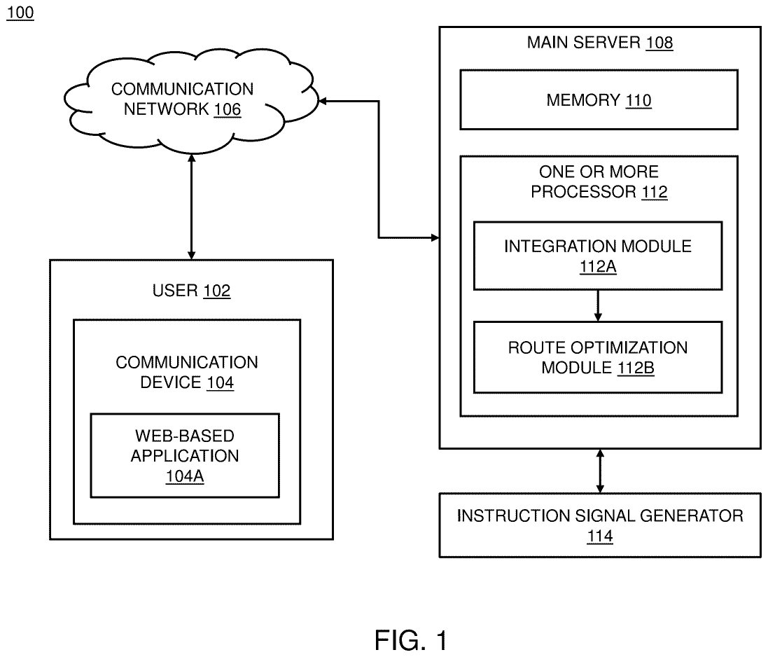

FIG. 1 illustrates a system 100 for optimizing route for a user 102, in accordance with various embodiments of the present disclosure. The system 100 includes a communication device 104, a web-based application 104a, a communication network 106, a main server 108, and an instruction signal generator 114. The main server 108 includes a memory 110, and one or more processor 112. The one or more processor 112 includes an integration module 112a and a route optimization module 112b.

The above stated elements of the system 100 operate coherently and synchronously with each other to optimize the route between any two geographic locations based on different parameters. The route is optimized based on a principle of integrating a road geographical information system with a graph database system. The elements of the system 100 utilize graph database theory along with the road geographical information system parameters for optimizing the route for the user 102. In addition, the route is optimized using a geohash technique which decreases storage space requirements and increases computational speed.

The geohashing technique employed by the system 100 significantly enhances the efficiency of the system 100. The system 100 reduces an amount of data that needs to be processed and stored by converting geographic coordinates into geohash codes. The conversion enables decrease in storage space requirements and speeds up the computation of optimal routes. The system 100 provides a highly efficient and adaptive route optimization solution through the integration of the road geographical information system with the graph database system and the application of geohash encoding. The system 100 addresses limitations of traditional GIS-based systems by offering improved computational performance, reduced storage requirements, and the ability to dynamically adapt to real-time data and conditions. The system 100 delivers an enhanced navigation experience for the user 102.

The system elements enable a lightweight implementation to derive road distances from data initially collected from Open Source(s). In addition, the system elements enable offline implementation to derive road distances from data initially collected from Open Source(s). The implementation is done based on area mapping rather than latitude and longitude mapping to reduce space requirements and improve computational performance. In addition, the system elements operate coherently to assist with several auxiliary tasks such as position and speed estimation and cleaning noisy inaccurate GPS data.

The system 100 delivers a highly efficient and adaptive route optimization solution that caters to the needs of both individual users and commercial enterprises. The system 100 facilitates accurate, real-time navigation and route planning. The system 100 is enabled for logistics and transportation businesses that demand precise and timely route calculations to enhance operational efficiency and reduce overall costs. In addition, the system 100 overcomes the limitations inherent in traditional GIS-based systems. The system 100 exhibits efficiency in handling large volumes of geographic data and in adapting to real-time traffic conditions. The system 100 employs geohash encoding and dynamic data updates, thereby ensuring reduced storage requirements and improved computational performance, which result in faster and more reliable route calculations.

Additionally, the system 100 aims to enhance the user experience by providing a seamless and intuitive interface for route planning. The system 100 enables users to input their travel preferences and constraints easily, resulting in the generation of personalized and optimized routes. As a result, the system 100 enhances an overall travel experience. Moreover, the system 100 is engineered to maintain high reliability even in adverse conditions. The system 100 offers accurate navigation guidance in scenarios where real-time GPS signals may be unavailable. The robustness of the system 100 ensures that users can rely on the system 100 for consistent and dependable route guidance.

The user 102 may be an individual user or any user belonging to an entity. In an example, the user 102 is an individual commuter utilizing the system 100 for daily travel between home and workplace. The user 102 utilizes the system 100 for real-time navigation and optimized route planning to minimize travel time and avoid traffic congestion. In another example, the user 102 may be a delivery driver employed by a logistics company. The user 102 relies on the system 100 to efficiently plan delivery routes, ensuring timely deliveries and reducing fuel consumption. In yet another example, the user 102 may be a fleet manager for a transportation company. The user 102 utilizes the system 100 to monitor and optimize the routes of multiple vehicles, enhancing overall fleet efficiency and reducing operational costs. In yet another example, the user 102 may be a public transportation operator, such as a bus driver, who uses the system 100 to navigate through urban routes, ensuring adherence to schedules and improving service reliability for passengers. In yet another example, the user 102 may be a service technician traveling to various customer locations for on-site repairs. The user 102 employs the system 100 to find most efficient routes between appointments, maximizing productivity and reducing travel time. In yet another example, the user 102 may be a sales representative responsible for visiting multiple client locations within a day. The system 100 assists the user 102 in optimizing their travel itinerary, allowing for more client visits and improved time management.

In an exemplary scenario, the user 102 may plan to drive or travel using any vehicle to commute from one location to another. The vehicle may be a two-wheeler, a three-wheeler, or a four-wheeler, depending upon a use case. In an embodiment of the present disclosure, the user 102 can be any individual who wants to travel from one location to another via optimized route. In another embodiment of the present disclosure, the user 102 can be someone from logistics sector who wants an optimized route for travel between source and destination for transportation of goods. The source and destination location can be hyperlocal, inter-state or intra-state. In addition, the user 102 defines some parameters to determine optimized route between source and destination location. In an embodiment of the present disclosure, the user 102 is in any indoor location (home, office, factory, cinema hall or any other type of indoor place). In another embodiment of the present disclosure, the user 102 is in any outdoor place (a mall, an amusement park, an airport, or any other type of outdoor place). In an embodiment of the present disclosure, the system 100 determines a travel one of a hyperlocal travel, an inter-state travel and an intra-state travel.

The user 102 is associated with the communication device 104. The communication device 104 are portable devices, which can function like a standard computer device in terms of operation, execution, and provision of services and applications. In general, the communication device 104 are devices, which can access wireless network infrastructure anytime and from any location to access transmitted data like voice, video, and text. In an embodiment of the present disclosure, the communication device 104 is a portable device which enables user interaction with other computing system present in an environment. In an embodiment of the present disclosure, the communication device 104 relies on wireless internet connection to execute tasks and deliver results. In another embodiment of present disclosure, the communication device 104 can operate without internet connection. Example of the communication device 104 are smartphones, laptop, desktops and tablets.

The user 102 accesses the web-based application 104a on the communication device 104. The web-based application 104a may be accessed through a web browser. In an exemplary scenario, the user 102 may access a mobile based application on the communication device 104. The mobile based application may be installed on the communication device 104. The web-based application 104a is a form of software which lets users connect with a remote server via a web browser. The web-based application 104a are application software which is accessed using a web browser. The web-based application 104 differs from a standard website because its outer appearance and functionality resemble those of a native application more than a website. In an embodiment of the present disclosure, the web-based application 104a enables the user 102 to access services through a web browser. In an embodiment of the present disclosure, the web-based application 104 establishes connections between the communication device 104 and the main server 108 (explained below in detail description). In an example implementation, the web-based application 104 is an interactive map application for accessing routes.

The communication network 106 is used for enabling communication flow between sender and the receiver. In general, the communication network 106 is a part of a network layer responsible for connection of two or more communication devices. Further, the communication network 106 may be any type of network. In an embodiment of the present disclosure, the type of communication network 106 is a wireless mobile network. In another embodiment of the present disclosure, the type of communication network 106 is a wired network with a finite bandwidth. In yet another embodiment of the present disclosure, the type of communication network 106 is a combination of the wireless and the wired network for the optimum throughput of data transmission. In yet another embodiment of the present disclosure, the type of communication network 106 is an optical fibre high bandwidth network that enables a high data rate with negligible connection drops. The communication network 106 provides a medium for the different elements of the environment to connect with the main server 108 (explained below in the detailed description).

The system 100 includes the main server 108. The main server 108 performs set of operations to process a request of the user 102. In various embodiments, the main server 108 performs a multitude of tasks, including but not limited to data storage, processing, and dissemination over a network. The main server 108 includes hardware components such as processors, memory modules, storage devices, and networking interfaces, as well as software components for managing and executing various functions. The main server 108 may further include features such as security protocols to ensure efficient and reliable operation. Additionally, the main server 108 may be scalable to accommodate varying workloads and may be configured for integration within distributed computing environments. Various aspects of the disclosure may be implemented using different architectures, protocols, and technologies, providing flexibility and adaptability to different usage scenarios. In an embodiment of the present disclosure, the main server 108 handles and performs each operation to optimize route. In another embodiment of present disclosure, the main server 108 stores database to identify various data related to geographical locations. Further, the main server 108 stores one or more instructions and one or more processor 112 for performing set of operations.

The main server 108 includes the memory 110. The memory 110 stores instructions which are required to perform processing, to provide output in response to the input received. The memory 110 is the place where all instructions are stored for the computer to operate or process the request made by the user 102. The memory 110 has various types such as cache memory, RAM and ROM. In an embodiment of the present disclosure, the memory 110 can be cache memory, which is a temporary storage space which is readily available for processor. In another embodiment of present disclosure, the memory 110 can be RAM (random access memory) which is a volatile memory that could store the data as long as the power is supplied. In an embodiment of the present disclosure, the memory 110 can be ROM (read only memory) which is a non-volatile memory that could retain the data even when the power is turned off.

The one or more processor 112 processes request made by any user. In an embodiment of the present disclosure, the one or more processor 112 performs set of operations to identify optimized route between two geographical locations. The one or more processor 112 performs program tasks, calculates data from input, and manages and coordinates other parts like memory, devices connected to the computer, and provides output or result. The one or more processor 112 gets instructions from the memory 110. The one or more processor 112 can be categorized into different types such as single-core processor, dual-core processor, and quad-core processor. In an embodiment of the present disclosure, the one or more processor 112 includes two main components to optimize route. The two main components are the integration module 112a and the route optimization module 112b. The integration module 112a and the route optimization module 112b may include sub-modules for performing the various steps for integration and route optimization.

The integration module 112a integrates a road geographical information system with a graph database system. Major advantage of this integration is that the system provides accurate road distance between two locations with low latency and high computational efficiency. The system overcomes limitations in the distance matrix faced in the traditional systems. The system solves the distance matrix problem via road APIs. The system provides a better way of searching routes by combining the graph database theory with the road APIs. This is due to the integration between the geohash and road API. The integration module 112a collects geographic locations data from various open sources. Road GIS data can be extracted from shapefiles, GeoJSON files, spatial databases such as, PostgreSQL with PostGIS extension, or completely opensource APIs such as OpenStreetMap. In an example implementation, the integration module 112a collects data from past trips of a plurality of users.

The integration module 112a integrates the road geographical information system with the graph database system. The integration module 112a is designed to obtain data in the form of a graph which consists of nodes and edges. Nodes represent geographic locations and edges represent routes connecting various nodes. In an example, the nodes are intersections, endpoints, landmarks, and the like. In an embodiment of the present disclosure, the integration of the graph database system with the road geographical information system enables usage of properties of the graph database system over and above the road geographical information system. The integration module 112a includes a geographic information system 202, an encoder 204 and a graph modelling unit 206. The geographic information system 202 includes a spatial database 202a. The encoder 204 includes a geohash encoding unit 204a. The graph modelling unit 206 includes a graph database 206a. It may be noted that the above system elements of the integration module 112a enable the integration of the road geographical information system with the graph database system; however, there may be more number of system elements in the integration module 112a.

The geographic information system 202 is a computer system for capturing, storing, checking, and displaying data related to positions on Earth's surface. The geographic information system 202 can show different kinds of data on one map, such as streets, buildings, and vegetation. The geographic information system 202 can use any information which includes locations. In an embodiment of the present disclosure, the geographic information system 202 expresses location in form of latitude and longitude. In another embodiment of the present disclosure, the geographic information system 202 expresses location in form of ZIP codes. The geographic information system 202 creates geographic data, manages geographic data in database, analyses and finds useful patterns associated with data. The geographic information system 202 includes the spatial database 202a. The spatial database 202a stores the data associated with locations.

The spatial database 202a contains tools to analyse and find patterns in the geographic data. The spatial database 202a stores location-address in the form of latitude and longitude which are billions and millions in number and require lot of storage space. The spatial database 202a stores data and information collected from open source. In an example, open source may be OpenStreetMap (OSM). Also, the spatial database 202a collects data of coordinates by directly using global position system devices. The spatial database 202a stores large amount of data of geographic location which enables mapping of geographical locations.

The encoder 204 is a combinational device for converting data from one format to another. The encoder 204 includes combinational circuits which are used to change the applied input signal into a coded format at the output. The encoder 204 takes input of locations from the geographic information system 202. The locations are in the form of latitude-longitude. The encoder 204 converts input coordinates into geohash codes. Geohash codes are collection of string characters and geohash codes represent locations.

The encoder 204 includes the geohash encoding unit 204a. The geohash encoding unit 204a takes a first set of data from the geographic information system 202. The first set of data can be defined as the initial collection of geographic information provided by the geographic information system 202. The geohash encoding unit 204a generates output in the form of geohash code. Geohash code is a collection of string of characters and digit. The string length can be of 8-12-character level. Precision of location depends on the length of string. In general, the precision of location is better with increase in number of string characters. Geohash codes are generated by dividing world into square grids. Each grid has a code associated with it, which are known as geohash. There are two types of geohash grid, one is 8×4 and 4×8 (width×height), which concludes that for any given zoom level, there are total 32 possible squares inside. Geohash is a hierarchical spatial data structure that encodes a geographic location into a short string of alphanumeric characters. Geohash represents a rectangular area on the Earth's surface.

The system 100 stores locations as geohashes, thus it reduces the amount of data required to store positions. The amount of data stored is less, therefore, it takes less computational power to load the data into memory before running the algorithm. The system 100 indexes the geohash nodes stored, this ensures faster querying of the nodes since every node now has a unique integer identifier. In an embodiment of the present disclosure, the system 100 does not operate on addresses. The system 100 operates on locations in the form of a latitude-longitude pair.

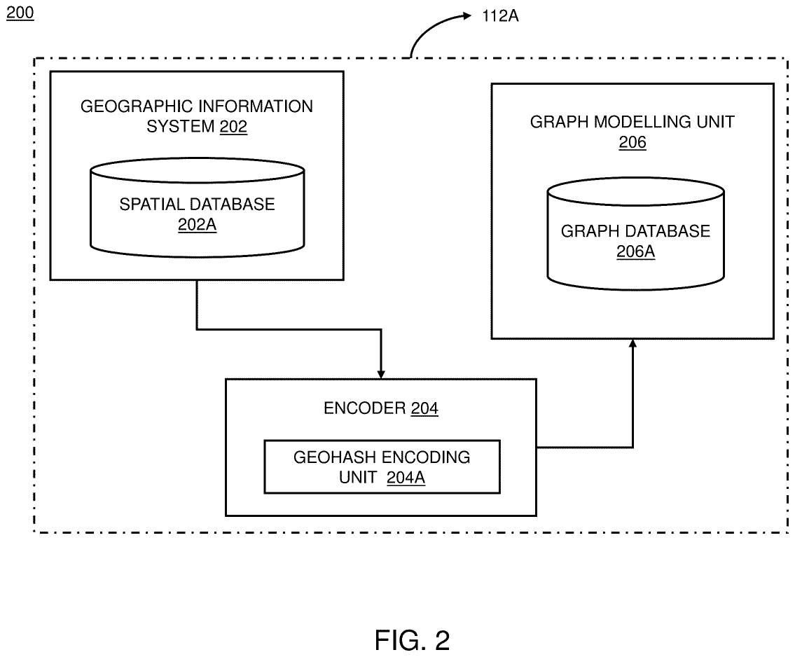

The integration module 112a (shown in the block diagram 200 of FIG. 2) collects a spatial aware data from one or more third party sources. In an example implementation, the one or more third party sources include open source data. The spatial aware data refers to data that has a geographical component, such as coordinates latitude and longitude, maps, or any information related to geographical locations. The one or more third party sources are external entities or services that provide data. They are not part of the system but are external providers or databases that offer the necessary spatial aware data. The integration module 112a extracts a first set of data from the spatial aware data from the one or more third party sources. The spatial aware database contains location specific data. The location specific data is collected from external open sources. The integration module 112a identifies and extracts useful data from the data which was initially collected by the geographic information system 202. The initially collected data is stored in the spatial database 202a. In an embodiment of the present disclosure, the first set of data includes data associated a road network. The road network data includes but may not be limited to geographic coordinates such as Latitude and longitude of specific locations, and coordinates of prominent points such as intersections, landmarks, or significant road segments. The road network data includes but may not be limited to road types (e.g., highways, arterial roads, local streets), road geometries and shapes, road lengths and orientations, road positions and alignments. In addition, the road network data may include traffic and travel conditions, road restrictions, such as closures or limitations on vehicle types. Moreover, the road network data includes locations of significant landmarks, businesses, and public facilities, city, county, and state boundaries, public transportation routes and stops, Bicycle lanes and pedestrian paths.

The integration module 112a converts the first set of data into plurality of nodes and a plurality of edges. In an embodiment of the present disclosure, the graph modelling unit 206 converts the first set of data in the form of graph which consists of nodes and edges. Each node of the plurality of nodes represents a set of prominent points. In an example, the set of prominent points correspond to intersections, endpoints, landmarks, and the like. The plurality of edges connects the plurality of nodes. Specifically, two consecutive nodes are connected through a single edge. The graph modelling unit 206 represents the first set of data in the form of graph. The graph consists of nodes and edges. The edges can be considered as road. Each edge of the plurality of edges represents a road segment connecting nodes, with properties such as distance, road type, speed limit, or other relevant attributes. In addition, each of the plurality of edges store various properties about the road such as distance, time, orientation of road, type of road and direction of road. Moreover, the plurality of edges can be bidirectional, if the road is two way or one directional, if the road is one way. The system 100 filters and clean the data related to the plurality of nodes. The system 100 keeps the data associated with the plurality of nodes which have data related to roads. Thus, a size of the system 100 reduces up to 80%. The system 100 filters and cleans the data before the extraction of the first set of data. In an embodiment of the present disclosure, each of the plurality of nodes has a pre-defined shape and a pre-defined area for each geohash level. The area for each of the plurality of nodes is uniform.

The plurality of nodes and the plurality of edges are captured using a grid of a pre-defined size at a corresponding geohash precision level. In an embodiment of the present disclosure, the grid of the pre-defined size at each subsequent geohash precision level other than the first geohash precision level is a combination of a plurality of grids at a previous geohash precision level. The geohash precision level corresponds to a granularity of geographic area representation using the geohash encoding system. The first geohash precision level is a base precision level taken for initiating mapping of the plurality of nodes. The first geohash precision level may be selected on a pre-defined basis. The first geohash precision level is represent by a corresponding character level. The character level refers to the length of the geohash string, where each character in the string increases the precision of the geographic representation. In addition, the character level in geohash denotes a length of the geohash string, with each character representing an increased level of precision by dividing the geographic area into smaller and more refined cells. In an embodiment of the present disclosure, the system 100 moves from a geohash level with a higher precision to each subsequent geohash level with lower precision. In another embodiment of the present disclosure, the system 100 moves from a geohash level with a lower precision to each subsequent geohash level with higher precision.

In a first scenario, the system 100 enables conversion and fetching of nodes and edges while moving from a lower geohash precision level to a higher geohash precision level. This is similar to zooming in on to a map. In an example, the first scenario may be utilized in case of hyperlocal travel within a city where the locations are near to each other. In an embodiment of the present disclosure, the first geohash precision level in the first scenario may be 8^{th} character level. In another embodiment of the present disclosure, the first geohash precision level in the first scenario may be one of 8^{th} character level to a 12^{th} character level. In an embodiment of the present disclosure, the pre-defined size of the grid corresponding to the first geohash precision level in the first scenario may be 39 m×19 m. In another embodiment of the present disclosure, the pre-defined size of the grid corresponding to the first geohash precision level in the first scenario may be different.

In a second scenario, the system 100 enables conversion and fetching of nodes and edges while moving from a higher geohash precision level to a lower geohash precision level. This is similar to zooming out of a map. In an example, the second scenario is relevant for locations which are at a greater distance from each other as compared to the first scenario. The second scenario may be used for inter-state travel. In an embodiment of the present disclosure, the first geohash precision level in the second scenario may be 3^{rd} character level. In another embodiment of the present disclosure, the first geohash precision level in the second scenario may be one of 3^{rd} character level to a 5^{th} character level. In an embodiment of the present disclosure, the pre-defined size of the grid corresponding to the first geohash precision level in the second scenario may be 39 m×19 m. In another embodiment of the present disclosure, the pre-defined size of the grid corresponding to the first geohash precision level in the second scenario may be different.

The grid at each precision level is a single grid. The size of the single grid increases from the higher precision level to the lower precision level. In an example, the first geohash precision level is 8^{th} character level according to the first scenario described above. So, the grid corresponding to the first geohash precision level contains a single rectangular box of the pre-defined size. The system 100 moves to a second precision level (7^{th} character level). So, the grid corresponding to the second geohash precision level is formed by combining multiple grids corresponding to the first geohash precision level. In another example, the first geohash precision level is 3^{rd} character level according to the second scenario described above. So, the grid corresponding to the first geohash precision level contains a single rectangular box of the pre-defined size. The system 100 moves to a second precision level (4^{th} character level). So, the grid corresponding to the second geohash precision level is formed by dividing multiple grids corresponding to the first geohash precision level. In an embodiment of the present disclosure, the multiple grids may be 4. In an embodiment of the present disclosure, the multiple grids may be more or less than 4. Similarly, the system 100 keeps on moving to the next precision level or lower precision levels with a grid formed with multiple previous grids corresponding to the previous precision level.

The graph modelling unit 206 stores the data in the graph database 206a. The graph database 206a stores all the data in graphical format. The graph database 206a defines relationship between the plurality of nodes using the plurality of edges. Each of the plurality of edges store information including but not limited to orientation of road, position of road, and type of road. The selection of technology for the graph database 206a should be based on the suitability of application and data requirements. The graph database 206a enables efficient querying and traversal of relevant data. The system 100 sets up indexing on graph database properties such as node identifiers, spatial coordinates, and the like. The system 100 optimizes the graph database schema and query performance based on common access patterns such as route planning, and spatial queries.

The integration module 112a applies graph database theory on the first set of data based on the converted plurality of nodes and the plurality of edges. The integration module 112a enables the integration of the road geographical information system with the graph database system. The integration corresponds to merging the graph database system with the road geographical information system. The integration module 112a dynamically updates an integrated system of the road geographical information system with the graph database system based on an updated first set of data. The updated first set of data corresponds to capturing of new nodes and edges in the graph database.

The integration module 112a denotes one or more edge properties to the plurality of edges on at least one level of a plurality of levels. The one or more edge properties are denoted using a set of parameters. The set of parameters are determined based on the first set of data. The set of parameters include one or a combination of the road network data parameters (as mentioned above). The one or more edge properties include distance, speed limit, time, orientation, type of road, and the like. The time is calculated based on the data of distance and speed limit of the road available from one or more sources. In an embodiment of the present disclosure, the one or more edge properties include time-based property, distance-based property, road type-based property, one or more restrictions, road orientation, road position and speed-based property, and the like. The time-based property refers to how much time is required to travel from first location to another depending on rush hours, traffic or distance. The road type-based property refers to whether the road is a highway, local road or urban road. The speed-based property refers to the speed limit of that road or speed data can be collected based on the historical trips.

In an embodiment of the present disclosure, the plurality of levels includes time-based edge property, distance-based edge property and number of nodes in between a start node and an end node for each corresponding travel route.

The integration module 112a dynamically updates the one or more edge properties based on a historical real-trip data fetched from one of a historical trip database or a third party data source. The one or more edge properties continuously get updated by fetching the historical real-trip data from one of the historical trip database or the third party data source. The integration module 112a tracks real time location, time and distance of a trip. The real time tracking helps in determining various properties of edges. Accordingly, the historical trip database is updated with increase in number of trips. In an example implementation, an individual travels from location A to location B. The average speed after finishing the trip is 34 km/h. The integration module 112a determines whether this distance from location A to B in the database is different from the currently obtained speed. The integration module 112a updates the historical trip database based on at least one of type of vehicles, time taken and average speed. Similarly, the integration module 112a updates the historical trip database with more trip data on a continuous basis.

The integration module 112a creates one or more clusters of a set of nodes of the plurality of nodes based on a travel corresponding to at least one trip based on the historical real-trip data. The one or more clusters are created using geohashing technique starting from a first geohash precision level to at least a second geohash precision level. The one or more clusters correspond to one or more sub-graphs in the graph database system. The set of nodes correspond to a nodes which are significant for travel corresponding to a particular route. The integration module 112a identifies the set of nodes on the graph database system using the historical real-trip data. Specifically, the set of nodes are points through which any user needs to pass through to reach a particular destination. Each cluster may be located or created at any point on the route depending on a travel information. The travel information includes source location, destination location, a type of travel, and the like. The type of travel includes hyperlocal travel, inter-state travel and intra-state travel. However, a person skilled in the art would appreciate that there can be more type of travel. The system 100 stores the one or more clusters and can fetch the cluster for any route in an efficient and quick manner without a need to traverse all the nodes. This ensures quick traversal and processing.

In an embodiment of the present disclosure, the integration module 112a creates one or more clusters of the set of nodes to identify at least a first node based on a first location of a user for travel to a second location. The first node is a nearest point on a road from the first location. The integration module 112a determines the set of nodes prominent to the identified first node corresponding to the travel to the second location. The set of nodes are determined based on the historical real-trip data corresponding to the travel from the first location to the second location. The integration module 112a dynamically updates the one or more clusters based on updated trip data.

In another embodiment of the present disclosure, the integration module 112a creates the one or more clusters of the set of nodes by identifying the set of nodes prominent to the identified first node using the grid at each corresponding geohash precision level. The size of the grid at each corresponding geohash precision level increases with increase in the geohash precision level. The system 100 is enabled to handle large quantities of data, as data can be stored in clusters based on specific areas. This approach allows for traversing only the relevant nodes within those clusters, instead of the entire dataset, to retrieve data.

The one or more processor 112 includes the route optimization module 112b. The route optimization module 112 determines an optimized route for the user 102 travelling from the first location to the second location. The route optimization module 112b optimizes the route between any two geographic locations based on different parameters. In general, the route optimization module 112b is designed to determine the most efficient routes for transportation. An optimized route is essential for entities related to logistics, delivery services, and transportation networks to minimize travel time, distance, and costs while maximizing efficiency and productivity. In an embodiment of the present disclosure, the route optimization module 112b operates using various algorithm for optimizing route, such as Dijkstra and A* algorithm. The route optimization module 112b utilizes edge properties used in graph theory for determining a shortest route between two nodes. In an embodiment of the present disclosure, Dijkstra's/A* Algorithm is used to calculate the shortest distance. However, it can be based on time, type of roads and traffic condition. The routes can be configured based on hyperlocal travel or not. Also, the system 100 may enable direct connection between a source node and a destination node depending upon a the travel information.

The route optimization module 112b receives a second set of data from a communication device 104 associated with the user 102. The second set of data includes the first location, the second location and at least one of the plurality of travel related contexts. In an example implementation, the user may mark or mention that they want to go from this building to another building. In an embodiment of the present disclosure, the graph database 206a contains data associated with roads. The user 102 generally travels from one building to another. In an example implementation, the system 100 enables the user 102 to type name of the building. The system 100 finds the closest grid or a closest node to that building to calculate route.

In an embodiment of present disclosure, the plurality of travel related contexts includes a time-based context, a distance based context, a road type based context, a speed limit based context, nodes based context and limitations on usage of certain types of roads and avoiding one or more areas. In an embodiment of present disclosure, the plurality of travel related contexts may not be limited to the above-mentioned parameters.

The route optimization module 112b identifies a first node and a second node on the graph database system. The first node is a closest node on the graph database system to the first location and the second node is the closest node of the graph database system to the second location. In an embodiment of the present disclosure, the system 100 starts navigation from the first node which is nearest to the first location of the user 102. In an example implementation, an individual wants an optimized route from location X to location Y. The route optimization module 112b identifies nearest point on road from location X and this point on road is termed as node A which is the first node. Similarly, for the destination location Y, the route optimization module 112b identifies nearest node which is the second node. In some implementations, the route optimization module 112b identifies the first node and the second node using haversine formula which calculates an aerial distance between two locations.

The route optimization module 112b determines the optimized route for the travel from the first node nearest from the first location to the second node nearest from the second location. The optimized route is determined at a corresponding geohash precision level. The geohash precision level for determining the optimized route is taken based on at least one of a set of pre-defined criteria. In an embodiment of the present disclosure, the set of pre-defined criteria includes one or a combination of at least one cluster of a set of nodes existing between the first location and the second location, a type of travel and at least one travel related context selected from the plurality of travel-related contexts. The type of travel includes one of a hyperlocal travel, an inter-state travel and an intra-state travel.

The route optimization module 112b fetches one or more routes from the first location to the second location based on the historical real-trip data. In an embodiment of the present disclosure, the route optimization module 112b fetches one or more routes from the first node closest to the first location to the second node closest to the second location. The route optimization module 112b fetches the one or more routes from the first node closest to the first location to the second node closest to the second location by performing a plurality of process steps. The plurality of process steps includes a first step of filtering the plurality of nodes based on the first node, the second node and the historical real-trip data corresponding to past trips between the first location and the second location. The plurality of process steps includes a second step of obtaining a sub-graph containing a first set of nodes after the filtering of the plurality of nodes. The plurality of process steps includes a third step of providing the one or more routes on the graph database system. In an embodiment of the present disclosure, the route optimization module 112b utilizes information related to the clusters between the one or more routes to speed up the filtering process.

The route optimization module 112b identifies at least a first point along on the one or more routes between with the first location and the second location. The first point is determined based on the set of pre-defined criteria. The first point is a point connecting a set of nodes and a set of edges corresponding to the one or more routes to a node associated with the first point on the graph database system. The route optimization module 112b determines the optimized route based on the identified first point, the first node, the second node and the at least one of the plurality of travel related contexts. The route optimization module 112 renders the optimized route on the communication device 104 of the user 102. In an example implementation, an individual wants to travel from source location A to a destination location B. The route optimization module 112b optimizes efficient route between node X to node Y, where node X is a nearest node to the source location A and node Y is a nearest node to the source location B. The route optimization 112b identifies the first point from the node X. This first point is the node where multiple routes converge. The first point becomes a crucial link or a node connecting various routes. The first point can be considered as an only bridge connecting two mountains or a point for exiting from one city to reach another city.

The system 100 fetches the one or more routes based on different parameters by determining subgraphs. In an example, a person wants to travel from node X to node Y, so the route optimization module 112b searches for routes which go outside node X. Let us say, node A is a place aligned on the border of both node X and node Y. So, the node A acts as a link to all the routes that are going out of node X. The route optimization module 112b only needs to search for route that connects node X and node A.

In an embodiment of the present disclosure, the optimized route contains the first set of nodes of the plurality of nodes connected using the first set of edges of the plurality of edges. The first set of edges are connected based on the edge properties determined based on at least one travel related context of the plurality of travel related contexts. In an example implementation, the context can be shortest distance, least time, least cost or avoiding toll. These contexts are selected by the user 102. Based on the context provided, the route optimization module 112b provides the optimized route.

The system 100 can optimize route between two geographic locations offline. The offline optimization can take place if the graph database is stored locally. The system 100 utilizes geohashes and polylines, this approach becomes more feasible compared to standard methods.

There are various techniques used for preprocessing graph to enable fast and efficient shortest path queries such as hub labelling and distance oracle. In an embodiment of the present disclosure, nodes are labelled with certain attributes like state, district, or pin code to enable faster querying by hub labelling in case where source and destination belongs to same hub. The idea of distance oracle is pre-embedded in the logic of edge creation. In an example, node X and node Y are source node and destination node respectively. If this route is very frequent, the route optimization module 112b directly connects the ‘last’ node X node to the first ‘first’ Y node. The route optimization module 112b creates a distance oracle since edge information from multiple edges is coagulated into a single edge. In the above example, shortest route between node X and node Y can be given by a single edge. In the above example, the route optimization module 112b does not need to utilize any shortest path algorithm.

In an embodiment of the present disclosure, the system 100 determines points nearest to nodes when exact latitude and longitude coordinates are unavailable. Considering X as the source and Y as the destination, the first step involves finding the closest point to X and Y in the graph database. The way the system 100 finds the closest point is very intuitive and the same for both the source and the destination. In second step, at source X, the system 100 starts with a big geohash accuracy (4-5-digit accuracy). The system 100 converts a latitude and longitude associated with the source X into a geohash and filter those nodes in the database that have the same geohash. The system 100 filters out the nodes that do not even belong to the big geohash. The system 100 repeats the process from the second step but with an increased geohash till the number of nodes falls below a threshold (let's say 100). Then, the system 100 calculates the haversine distance between these 100 nodes and the source X and selects the closest node to the source X. The closest node is accurate since the system 100 contains the information for the roads and almost all buildings and landmarks are reachable via roads.

The instruction signal generator 114 is communicatively coupled with the main server 108. The instruction signal generator 114 is a component or module which generates signal. In an embodiment of the present disclosure, the instruction signal generator 114 refers to the component which generates navigational signals or instructions. The instruction signal generator 114 is configured for generating one or more signals pertaining to one or more alert signals corresponding to the optimization of the route for the travel from the first location to the second location. The system 100 enables reduction in storage space requirements by storing and fetching relevant node data in the graph database system based on the plurality of travel related contexts and storing data associated with grids containing road data and the system 100 enables improvement in computational performance and increases a calculation speed for the optimized route based on a context provided by the user.

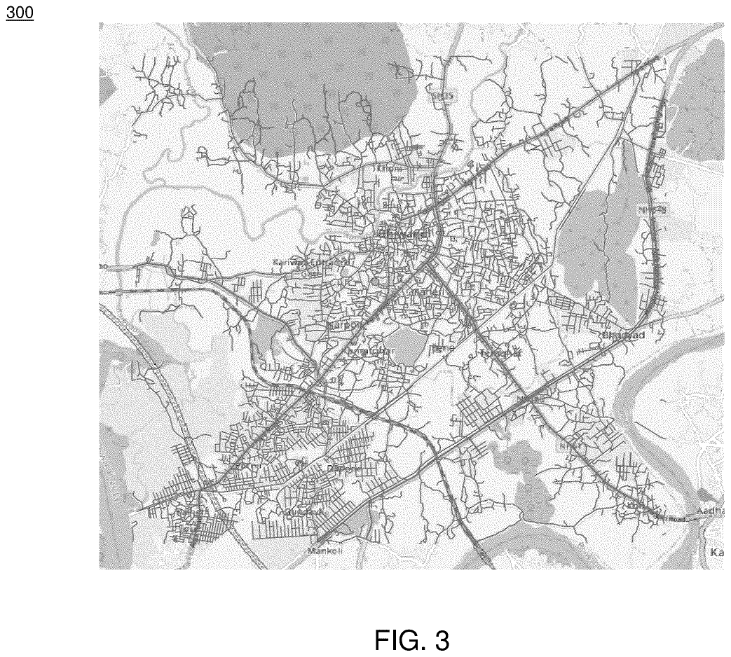

FIG. 3 illustrates a graphical representation 300 of an exemplary geographical region showing polylines, in accordance with various embodiments of the present disclosure. The polyline is a connected sequence of vertices connected to from an edge. The route established between two nodes is a combination of polylines. The polyline is a series of connected line segments that are used to represent a continuous path or route on a map or in a two-dimensional space. Polyline is commonly used in Geographic Information Systems (GIS), mapping applications, and computer graphics to visually represent complex shapes or trajectories using a sequence of straight-line segments. Various polylines can be combined reducing the load, for keeping track of number of polylines present in the route between two points. Polylines are used to approximate curves, paths, or boundaries with straight-line segments, providing a simplified representation of complex shapes. They are versatile and can represent both open paths, not forming a closed loop and closed shapes, forming a closed loop.

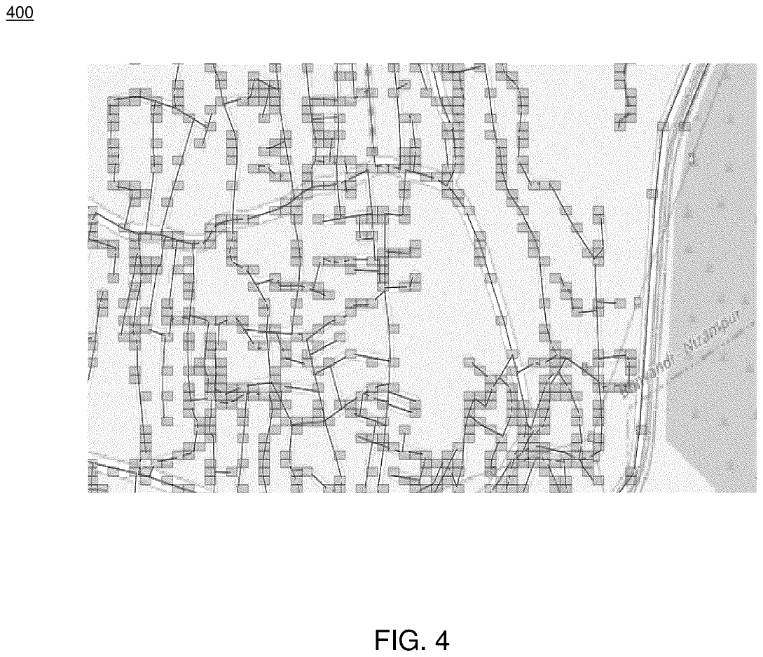

FIG. 4 illustrates a graphical representation 400 of the exemplary geographical region of FIG. 3 showing the nodes and the polylines, in accordance with various embodiments of the present disclosure. The graph consists of polylines and nodes of particular region. The nodes are the rectangular box which can be seen in the image and the polylines are the edges connecting nodes. The polyline is a set of latitude-longitude locations on which a line can be drawn in an ordered sequence.

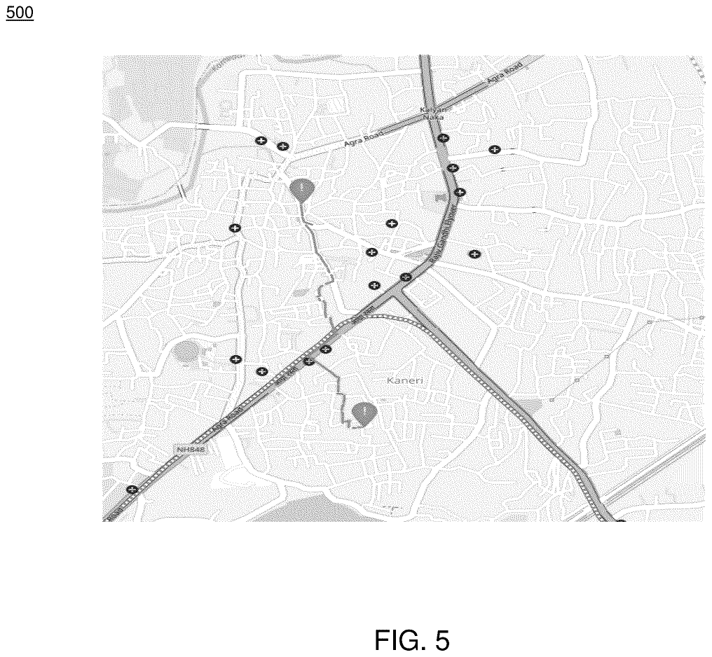

FIG. 5 illustrates a graphical representation 500 of the exemplary geographical region of edges connecting two geographical locations of a specific region, in accordance with various embodiments of the present disclosure. The graphical representation 500 shows the edges connecting two geographical locations of a specific region. The graph(map) represents two end points on road out of which one is starting point from where the journey begins and other one is the end point which is destination point and nodes are connected by an edge. Edge in the image is the route which has been optimized by the route optimization algorithm based on different parameters such as distance, time, and average speed.

In the optimized route, multiple polylines passing through multiple nodes are combined to form a single polyline to form the optimized route. Polylines are the series of connected lines. Polylines are not necessarily closed loop. Polylines are sequence of vertices connected by the segment of straight line. The output (optimized route) for the user is always a polyline.

In an embodiment of the present disclosure, the route optimization module 112b performs a set of operations to determine the optimized route between two nodes. The user 102 specifies the criteria for route optimization. The route optimization module 112b first fetches geographic location data from the integration module 112a. The route optimization module 112b does not consider the map or graph of the entire world while optimizing the route, which helps in optimizing the system's storage space. The route optimization module 112b identifies the nearest location on the road from the user's location, which is considered as the source node. The route optimization module 112b starts route optimization from the base level. In an embodiment, the base level may be any level selected from a range of 8-12 character level according to the first scenario. The route optimization module 112b identifies nodes at the 7th character level if the base level is the 8th character level. In another embodiment, the base level may be any level selected from a range of 3-6 character level according to the second scenario. The route optimization module 112b identifies nodes at the 4th character level if the base level is the 3^{rd} character level. In an embodiment, optimization of route depends on cluster, included both zoom in and zoom out, and can happen based on geohash character and nodes and edges clustering.

Such nodes are the links connecting source and destination points. Moving from the 8th to the 7th character level means moving from a smaller grid to a bigger one, which covers a larger geographic area and consists of relevant nodes that will connect the source and destination points. The system 100 identifies the nodes associated with the route from source to destination. Different routes are calculated based on the context provided by the user 102. There are some common nodes that may exist in at least two or more routes and act as connection links. The user 102 must visit these nodes while traveling from source to destination. Such nodes can be termed relevant nodes and are grouped into one cluster. Since there is more than one edge connecting the source and destination, the edge that satisfies the user's criteria is selected for route optimization. The algorithms used for route optimization include Dijkstra and A*.

In an embodiment of the present disclosure, the two nodes (the first node and the second node) can be hyperlocal. Let us take an example where a user provides input such as source node X, destination node Y, and criteria based on which the route should be optimized. Let's say the criteria for route optimization are least time and avoiding highways. The system 100 first fetches the first set of data (graph) from the integration module 112a. After fetching the graph, the route optimization module 112b identifies the routes or edges connecting node X and node Y. The route optimization module 112b optimizes the route based on the criteria given by the user 102 and determines edges with the least time connecting the node X and Y. Once the route is optimized, the route optimization module 112b determines the nodes that between the node X and the node Y. Suppose, there are four nodes between X and Y, say X1, X2, X3 and X4. Now, the route optimization module 112b again optimizes the route between node X and node X1. Lets say, there are 3 edges between node X and node X1 depending upon the type of road, and different routes to reach from one node to another. The system 100 selects the edge with the least time. However, there may be a highway that exists between node X and node X1 (let's call that point A where the highway starts). Then, the route optimization module 112b again optimizes the route between node A and node X1. Once the user reaches X1, the route optimization module 112b identifies another relevant node and determine the optimized route from X1 to the other relevant node. When the user starts from node X, the route optimization module 112b keeps updating edge properties. The route optimization module 112b dynamically updates these properties of edges and continuously identifies relevant nodes and renders the final route to the user 102.

In another embodiment of the present disclosure, the two nodes are interstate. Let the source node X be in one state and the destination node Y be in another state. The user wants to obtain the optimized route between node X and Y in terms of the shortest distance and least cost. The system fetches data from the integration module 112a. The data is in form of a graph and graph consists of nodes and edges. The route optimization module 112b optimizes route using the data fetched from the integration module 112a. The route optimization module 112b first identifies edges which connects node X to node Y. Let us assume there are 3 edges connecting node X and node Y, now all these edges contain properties such as distance, time, speed, type of road, orientation of the road. The route optimization module 112b optimizes route based on the travel-related context provided by the user 102. The route optimization module 112b uses algorithm such as Dijkstra and A* to identify the edges with the shortest distance between node X and node Y. The route optimization module 112b uses historical data to determine least cost, so the edges with a lesser distance than other edges and which avoid tolls are determined. When the user starts travelling from node X, the route optimization module 112b identifies first relevant node, let's say the relevant node is X1. The system again optimizes route between node X and X1. Lets say, there are 4 edges between node X and node X1 depending upon the type of road, and different routes to reach from one node to another. The route optimization module 112b again optimizes route between X and X1 based on the travel-related context. Lets say, there exists one toll between X and X1. The route optimization module 112b again identifies another route to avoid this toll. The route optimization module 112b continuously performs these set of operations and provides a final route to the user 102.

In an embodiment of the present disclosure, the user provides various context such as visiting least grid. The meaning of visiting least grids corresponds to a route where the user travels the least, such as in the case where least nodes are chosen as the travel context. Grids and geohashes are interchangeable. Therefore, when the context is to visit the least number of grids, it means that the user wants to visit the least number of geohash nodes between the source and the destination.

In an embodiment of the present disclosure, the system 100 enables a compression by at least 95%. Let's assume the geohash precision level to be 8. The grid size of the geohash is 38.2 m×19.1 m. The compression percentage can be calculated by assuming a latitude longitude accuracy of 5 decimal places. In an example, a point is considered with a latitude and longitude of 76.24326 and 72.24544. The distance between two lat-long points differing in the last decimal point for latitude is 1.112 m, where points considered are 76.34325, 72.34544 and 76.34324,72.34544. The distance between two lat-long points differing in the last decimal point for longitude is 0.26254 m, where points considered are 76.34324, 72.34545 and 76.34324,72.34544. Therefore, total area covered by individual lat-long pair is 1.112×0.26254=0.2919 sq m. So, the compression percentage is calculated as

Compression Percentage=(1−0.2919/729.62)×100=99.96%, which is 95% or more

It may be noted that in FIG. 1, the system 100 optimizes the route for the user 102; however, those skilled in the art would appreciate that the system 100 optimizes the route for more users. It may be noted that in FIG. 1, the system 100 renders the optimized route on the communication device 104 associated with the user 102; however, those skilled in the art would appreciate that the system 100 renders the optimized route on more number of communication devices associated with more number of users.

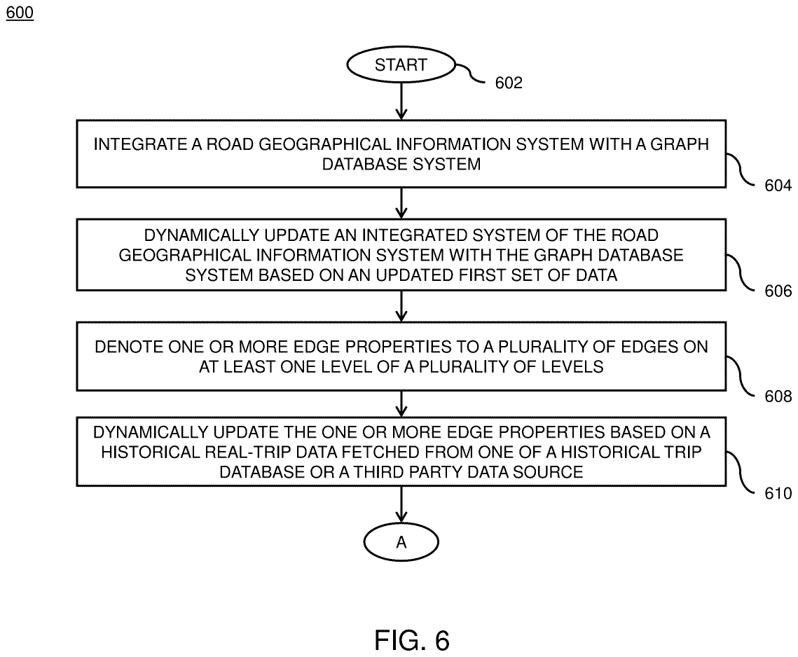

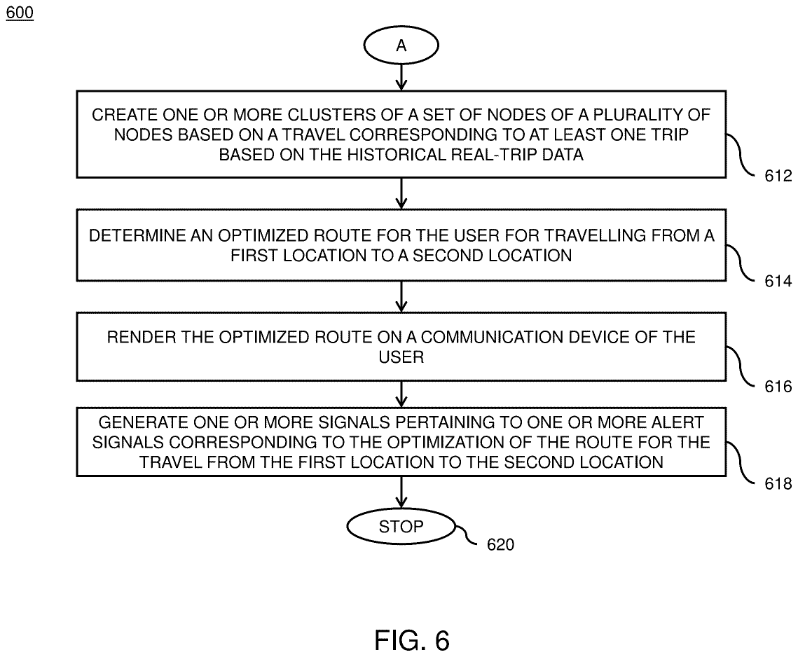

FIG. 6 illustrates a flowchart 600 of a method for optimizing the route for the user 102, in accordance with various embodiments of the present disclosure. It may be noted that in order to explain the method of the flowchart 600, references will be made to the elements explained in FIG. 1. The flow chart 600 starts at step 602. At step 604, the system 100 integrates the road geographical information system with the graph database system. The integration of the road geographical information system with the graph database system includes collecting the spatial aware data from the one or more third party sources, extracting the first set of data from the spatial aware data from the one or more third party sources, converting the first set of data into the plurality of nodes and the plurality of edges and applying graph database theory on the first set of data based on the converted plurality of nodes and the plurality of edges for enabling the integration of the road geographical information system with the graph database system. The integration corresponds to merging the graph database system with the road geographical information system. At step 606, the system 100 dynamically updates the integrated system of the road geographical information system with the graph database system based on the updated first set of data. At step 608, the system 100 denotes the one or more edge properties to the plurality of edges on at least one level of the plurality of levels. The one or more edge properties are denoted using the set of parameters. The set of parameters are determined based on the first set of data. At step 610, the system 100 dynamically updates the one or more edge properties based on the historical real-trip data fetched from one of the historical trip database or the third party data source. At step 612, the system 100 creates the one or more clusters of the set of nodes of the plurality of nodes based on the travel corresponding to at least one trip based on the historical real-trip data. The one or more clusters are created using the geo-hashing technique starting from the first geohash precision level to at least the second geohash precision level. The one or more clusters correspond to the one or more sub-graphs in the graph database system. At step 614, the system 100 determines the optimized route for the user for travelling from the first location to the second location. The optimized route is determined by receiving the second set of data from the communication device 104 associated with the user 102, identifying the first node and the second node on the graph database system and determining the optimized route for the travel from the first node nearest from the first location to the second node nearest from the second location. The second set of data includes the first location, the second location and at least one of the plurality of travel related contexts. At step 616, the system 100 renders the optimized route on the communication device 104 of the user 102. At step 618, the system 100 generates the one or more signals pertaining to the one or more alert signals corresponding to the optimization of the route for the travel from the first location to the second location. The method shown in the flowchart 600 enables reduction in storage space requirements by enabling storing and fetching relevant node data in the graph database system based on the plurality of travel related contexts. In addition, the method enables storing data associated with grids containing road data. The method enables improvement in computational performance and increases calculation speed for the optimized route based on a context provided by the user.

The flow chart 600 terminates at step 620. It may be noted that the flowchart 600 is explained to have above stated process steps; however, those skilled in the art would appreciate that the flowchart 600 may have more/less number of process steps which may enable all the above stated embodiments of the present disclosure.

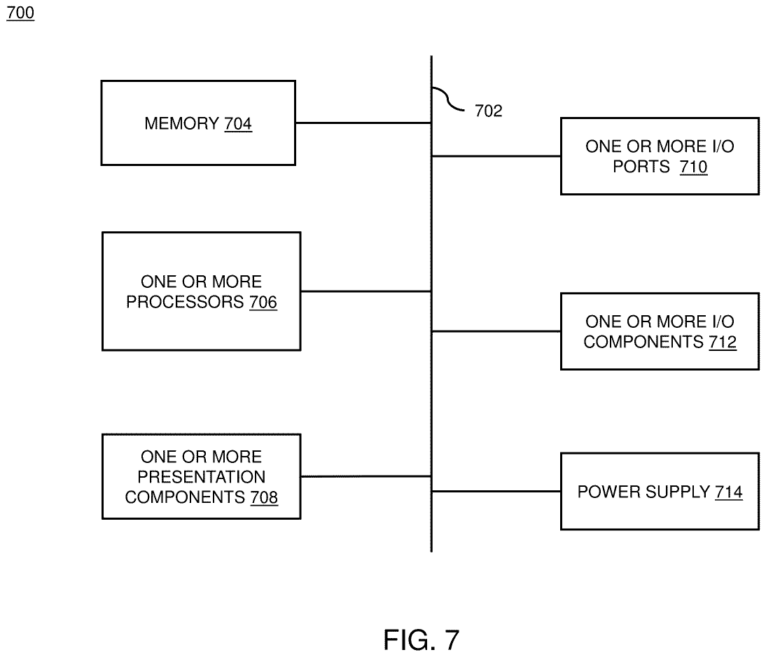

FIG. 7 illustrates a block diagram of a computing device 700, in accordance with various embodiments of the present disclosure. The computing device 700 includes a bus 702 that directly or indirectly couples the following devices: a memory 704, one or more processors 706, one or more presentation components 708, one or more input/output (I/O) ports 710, one or more input/output components 712, and an illustrative power supply 714. The bus 702 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device 700 that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

The computing device 700 typically includes a variety of computer-readable media. The computer-readable media can be any available media that can be accessed by the computing device 700 and includes both volatile and nonvolatile media, removable and non-removable media. By way of example, and not limitation, the computer-readable media may comprise computer storage media and communication media

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for optimizing a route for a user, the computer-implemented method comprising:
integrating, by one or more processors, a road geographical information system with a graph database system, wherein the integration of the road geographical information system with the graph database system comprises:
collecting a spatial aware data from one or more third party sources;
extracting a first set of data from the spatial aware data from the one or more third party sources;
converting the first set of data into plurality of nodes and a plurality of edges, wherein each node of the plurality of nodes represents a set of prominent points, wherein the plurality of edges connect the plurality of nodes, wherein the plurality of nodes and the plurality of edges are captured using a grid of a pre-defined size at a corresponding geohash precision level;
applying graph database theory on the first set of data based on the converted plurality of nodes and the plurality of edges for enabling the integration of the road geographical information system with the graph database system, wherein the integration corresponds to merging the graph database system with the road geographical information system;
dynamically updating, by the one or more processors, an integrated system of the road geographical information system with the graph database system based on an updated first set of data;
denoting, by the one or more processors, one or more edge properties to the plurality of edges on at least one level of a plurality of levels, wherein the one or more edge properties are denoted using a set of parameters, wherein the set of parameters are determined based on the first set of data;
dynamically updating, by the one or more processors, the one or more edge properties based on a historical real-trip data fetched from one of a historical trip database or a third party data source;
creating, by the one or more processors, one or more clusters of a set of nodes of the plurality of nodes based on a travel corresponding to at least one trip based on the historical real-trip data, wherein the one or more clusters are created using geohashing technique starting from a first geohash precision level to at least a second geohash precision level, wherein the one or more clusters correspond to one or more sub-graphs in the graph database system;
determining, by the one or more processors, an optimized route for a user for travelling from a first location to a second location, wherein the determining the optimized route comprises:
receiving a second set of data from a communication device associated with a user, wherein the second set of data comprises the first location, the second location and at least one of a plurality of travel related contexts;
identifying a first node and a second node on the graph database system, wherein the first node is a closest node on the graph database system to the first location and the second node is a closest node of the graph database system to the second location;
determining the optimized route for the travel from the first node nearest from the first location to the second node nearest from the second location, wherein the optimized route is determined at a corresponding geohash precision level, wherein the geohash precision level for determining the optimized route is taken based on at least one of a set of pre-defined criteria, wherein the optimized route is determined by:
fetching one or more routes from the first location to the second location based on the historical real-trip data;
identifying at least a first point along on the one or more routes between with the first location and the second location, wherein the first point is determined based on the set of pre-defined criteria and wherein the first point is a point connecting a set of nodes and a set of edges corresponding to the one or more routes to a node associated with the first point on the graph database system;
determining the optimized route based on the identified first point, the first node, the second node and the at least one of the plurality of travel related contexts;
rendering, by the one or more processors, the optimized route on the communication device of the user; and
generating, by the one or more processors, one or more signals pertaining to one or more alert signals corresponding to the optimization of the route for the travel from the first location to the second location,
wherein the computer-implemented method enables reduction in storage space requirements by enabling storing and fetching relevant node data in the graph database system based on the plurality of travel related contexts and enabling storing data associated with grids containing road data and wherein the method enables improvement in computational performance and increases a calculation speed for the optimized route based on a context provided by the user.

2. The computer-implemented method as recited in claim 1, wherein the fetching of the one or more routes from the first node closest to the first location to the second node closest to the second location is done by:
filtering the plurality of nodes based on the first node, the second node and the historical real-trip data corresponding to past trips between the first location and the second location;
obtaining a sub-graph containing a first set of nodes after the filtering of the plurality of nodes; and
providing the one or more routes.

3. The computer system as claimed in claim 1, wherein the one or more edge properties correspond to time-based property, distance-based property, road type-based property, one or more restrictions, road orientation, road position and speed-based property.

4. The computer system as claimed in claim 1, wherein the plurality of levels comprises time-based edge property, distance-based edge property and number of nodes in between a start node and an end node for each corresponding travel route.

5. The computer-implemented method as recited in claim 1, wherein the plurality of travel related contexts comprises a time-based context, a distance-based context, a road type-based context, a speed limit-based context, nodes-based context and limitations on usage of certain types of roads and avoiding one or more areas.

6. The computer-implemented method as recited in claim 1, wherein the optimized route comprises a first set of nodes of the plurality of nodes connected using a first set of edges of the plurality of edges, wherein the first set of edges are connected based on one or more edge properties determined based on at least one travel related context of the plurality of travel related contexts.

7. The computer-implemented method as recited in claim 1, wherein each of the plurality of nodes has a pre-defined shape and a pre-defined area for each geohash level, wherein the area for each of the plurality of nodes is uniform.

8. The computer-implemented method as recited in claim 1, wherein the creation of the one or more clusters of the set of nodes of the plurality of nodes comprises:
identifying at least a first node based on a first location of a user for travel to a second location, wherein the first node is a nearest point on a road from the first location;
determining the set of nodes prominent to the identified first node corresponding to the travel to the second location, wherein the set of nodes are determined based on the historical real-trip data corresponding to the travel from the first location to the second location; and
dynamically updating the one or more clusters based on updated trip data.

9. The computer-implemented method as recited in claim 1, wherein the creation of the one or more clusters of the set of nodes comprises:
identifying the set of nodes prominent to the identified first node using the grid at each corresponding geohash precision level, wherein a size of the grid at each corresponding geohash precision level increases with increase in the geohash precision level.

10. The computer-implemented method as recited in claim 1, wherein the grid of the pre-defined size at each subsequent geohash precision level other than the first geohash precision level is a combination of a plurality of grids at a previous geohash precision level.

11. The computer-implemented method as recited in claim 1, wherein the set of pre-defined criteria comprises one or a combination of at least one cluster of a set of nodes existing between the first location and the second location, a type of travel and at least one travel related context selected from the plurality of travel-related contexts, wherein the type of travel comprises one of a hyperlocal travel, an inter-state travel and an intra-state travel.

12. A computer system comprising:
a main server, the main server comprising:
a memory; and
one or more processors operatively coupled to the memory, the one or more processors being configured to perform a set of instructions, the set of instructions comprising:
integrating a road geographical information system with a graph database system, wherein the integration of the road geographical information system with the graph database system comprises:
collecting a spatial aware data from one or more third party sources;
extracting a first set of data from the spatial aware data from the one or more third party sources;
converting the first set of data into plurality of nodes and a plurality of edges, wherein each node of the plurality of nodes represents a set of prominent points, wherein the plurality of edges connect the plurality of nodes, wherein the plurality of nodes and the plurality of edges are captured using a grid of a pre-defined size at a corresponding geohash precision level;
applying graph database theory on the first set of data based on the converted plurality of nodes and the plurality of edges for enabling the integration of the road geographical information system with the graph database system, wherein the integration corresponds to merging the graph database system with the road geographical information system;
dynamically updating an integrated system of the road geographical information system with the graph database system based on an updated first set of data;
denoting one or more edge properties to the plurality of edges on at least one level of a plurality of levels, wherein the one or more edge properties are denoted using a set of parameters, wherein the set of parameters are determined based on the first set of data;
dynamically updating the one or more edge properties based on a historical real-trip data fetched from one of a historical trip database or a third party data source;
creating one or more clusters of a set of nodes of the plurality of nodes based on a travel corresponding to at least one trip based on the historical real-trip data, wherein the one or more clusters are created using geohashing technique starting from a first geohash precision level to at least a second geohash precision level, wherein the one or more clusters correspond to one or more sub-graphs in the graph database system;
determining an optimized route for a user for travelling from a first location to a second location, wherein the determining the optimized route comprises:
receiving a second set of data from a communication device associated with a user, wherein the second set of data comprises the first location, the second location and at least one of a plurality of travel related contexts;
identifying a first node and a second node on the graph database system, wherein the first node is a closest node on the graph database system to the first location and the second node is a closest node of the graph database system to the second location;
determining the optimized route for the travel from the first node nearest from the first location to the second node nearest from the second location, wherein the optimized route is determined at a corresponding geohash precision level, wherein the geohash precision level for determining the optimized route is taken based on at least one of a set of pre-defined criteria, wherein the optimized route is determined by:
fetching one or more routes from the first location to the second location based on the historical real-trip data;
identifying at least a first point along on the one or more routes between with the first location and the second location, wherein the first point is determined based on the set of pre-defined criteria and wherein the first point is a point connecting a set of nodes and a set of edges corresponding to the one or more routes to a node associated with the first point on the graph database system;
determining the optimized route based on the identified first point, the first node, the second node and the at least one of the plurality of travel related contexts;
rendering the optimized route on the communication device of the user; and
an instruction signal generator communicatively coupled with the main server, wherein the instruction signal generator is configured for generating one or more signals pertaining to one or more alert signals corresponding to the optimization of the route for the travel from the first location to the second location,
wherein the computer system enables reduction in storage space requirements by storing and fetching relevant node data in the graph database system based on the plurality of travel related contexts and storing data associated with grids containing road data and wherein the computer system enables improvement in computational performance and increases a calculation speed for the optimized route based on a context provided by the user.

13. The computer system as claimed in claim 12, wherein the fetching of the one or more routes from the first node closest to the first location to the second node closest to the second location is done by:
filtering the plurality of nodes based on the first node, the second node and the historical real-trip data corresponding to past trips between the first location and the second location;
obtaining a sub-graph containing a first set of nodes after the filtering of the plurality of nodes; and
providing the one or more routes on the graph database system.

14. The computer system as claimed in claim 12, wherein the one or more edge properties correspond to time-based property, distance-based property, road type-based property, one or more restrictions, road orientation, road position and speed-based property.

15. The computer system as claimed in claim 12, wherein the plurality of travel related contexts comprises a time-based context, a distance-based context, a road type-based context, a speed limit-based context, nodes-based context and limitations on usage of certain types of roads and avoiding one or more areas.

16. The computer system as claimed in claim 12, wherein the optimized route comprises a first set of nodes of the plurality of nodes connected using a first set of edges of the plurality of edges, wherein the first set of edges are connected based on one or more edge properties determined based on at least one travel related context of the plurality of travel related contexts.

17. The computer system as claimed in claim 12, wherein the creation of the one or more clusters of the set of nodes of the plurality of nodes comprises:
identifying at least a first node based on a first location of a user for travel to a second location, wherein the first node is a nearest point on a road from the first location;
determining the set of nodes prominent to the identified first node corresponding to the travel to the second location, wherein the set of nodes are determined based on the historical real-trip data corresponding to the travel from the first location to the second location; and
dynamically updating the one or more clusters based on updated trip data.

18. The computer system as claimed in claim 12, wherein the creation of the one or more clusters of the set of nodes comprises:
identifying the set of nodes prominent to the identified first node using the grid at each corresponding geohash precision level, wherein a size of the grid at each corresponding geohash precision level increases with increase in the geohash precision level.

19. The computer system as claimed in claim 12, wherein the set of pre-defined criteria comprises one or a combination of at least one cluster of a set of nodes existing between the first location and the second location, a type of travel and at least one travel related context selected from the plurality of travel-related contexts, wherein the type of travel comprises one of a hyperlocal travel, an inter-state travel and an intra-state travel.

20. A non-transitory computer-readable storage medium encoding computer executable instructions that, when executed by at least one processor, performs a method for optimizing a route for a user, the method comprising:
integrating, at a computing device, a road geographical information system with a graph database system, wherein the integration of the road geographical information system with the graph database system comprises:
collecting a spatial aware data from one or more third party sources;
extracting a first set of data from the spatial aware data from the one or more third party sources;
converting the first set of data into plurality of nodes and a plurality of edges, wherein each node of the plurality of nodes represents a set of prominent points, wherein the plurality of edges connect the plurality of nodes, wherein the plurality of nodes and the plurality of edges are captured using a grid of a pre-defined size at a corresponding geohash precision level;
applying, at the computing device, graph database theory on the first set of data based on the converted plurality of nodes and the plurality of edges for enabling the integration of the road geographical information system with the graph database system, wherein the integration corresponds to merging the graph database system with the road geographical information system;
dynamically updating, at the computing device, an integrated system of the road geographical information system with the graph database system based on an updated first set of data;
denoting, at the computing device, one or more edge properties to the plurality of edges on at least one level of a plurality of levels, wherein the one or more edge properties are denoted using a set of parameters, wherein the set of parameters are determined based on the first set of data;
dynamically updating, at the computing device, the one or more edge properties based on a historical real-trip data fetched from one of a historical trip database or a third party data source;
creating, at the computing device, one or more clusters of a set of nodes of the plurality of nodes based on a travel corresponding to at least one trip based on the historical real-trip data, wherein the one or more clusters are created using geohashing technique starting from a first geohash precision level to at least a second geohash precision level, wherein the one or more clusters correspond to one or more sub-graphs in the graph database system;
determining, at the computing device, an optimized route for a user for travelling from a first location to a second location, wherein the determining the optimized route comprises:
receiving a second set of data from a communication device associated with a user, wherein the second set of data comprises the first location, the second location and at least one of a plurality of travel related contexts;
identifying a first node and a second node on the graph database system, wherein the first node is a closest node on the graph database system to the first location and the second node is a closest node of the graph database system to the second location;
determining the optimized route for the travel from the first node nearest from the first location to the second node nearest from the second location, wherein the optimized route is determined at a corresponding geohash precision level, wherein the geohash precision level for determining the optimized route is taken based on at least one of a set of pre-defined criteria, wherein the optimized route is determined by:
fetching one or more routes from the first location to the second location based on the historical real-trip data;
identifying at least a first point along on the one or more routes between with the first location and the second location, wherein the first point is determined based on the set of pre-defined criteria and wherein the first point is a point connecting a set of nodes and a set of edges corresponding to the one or more routes to a node associated with the first point on the graph database system;
determining the optimized route based on the identified first point, the first node, the second node and the at least one of the plurality of travel related contexts;
rendering the optimized route on the communication device of the user; and
generating, at the computing device, one or more signals pertaining to one or more alert signals corresponding to the optimization of the route for the travel from the first location to the second location,
wherein the method enables reduction in storage space requirements by enabling storing and fetching relevant node data in the graph database system based on the plurality of travel related contexts and enabling storing data associated with grids containing road data and wherein the method enables improvement in computational performance and increases a calculation speed for the optimized route based on a context provided by the user.
